(19) United States
(12) Patent Application Publication
(10) Pub. No.: US 2016/0104436 A1
(43) Pub. Date: Apr. 14, 2016

(54) DISPLAY APPARATUS AND METHOD OF DRIVING THE SAME

(71) Applicant: Samsung Display Co., Ltd., Yongin-City (KR)

(72) Inventors: Bonseog Gu, Yongin-City (KR); Jaehyun Cho, Yongin-City (KR); Taejin Kim, Yongin-City (KR)

(21) Appl. No.: 14/662,070

(22) Filed: Mar. 18, 2015

(30) Foreign Application Priority Data
Oct. 10, 2014 (KR) 10-2014-0136969

(51) Int. Cl. G09G 3/34; G09G 3/36; G09G 3/20

(52) U.S. Cl. CPC G09G 3/3413; G09G 3/2003; G09G 3/2074; G09G 3/2022; G09G 3/3648; G09G 3/3688; G09G 2310/027; G09G 2310/08; G09G 2320/064; G09G 2370/16

(57) ABSTRACT

There is provided a method of driving a display apparatus including a display panel having a plurality of pixels, a light source unit emitting light toward the display panel, and a control unit controlling the display panel and the light source unit. The method includes: displaying a light-emitting mode by operating the control unit to turn on a light source of the light source unit and transmit pixel data to the display panel; and displaying a non-light-emitting mode by operating the control unit to turn off the light source of the light source unit and turn on at least one pixel of the display panel.

### RELATED APPLICATION

This application claims the benefit of Korean Patent Application No. 10-2014-0136969, filed on Oct. 10, 2014, in the Korean Intellectual Property Office, the disclosure of which is incorporated herein in its entirety by reference.

### BACKGROUND

1. Field

One or more exemplary embodiments relate to a display apparatus and a method of driving the display apparatus.

2. Description of the Related Art

Examples of displays include liquid crystal displays (LCDs) and organic light emitting diode displays. Such a display includes: a display panel including a plurality of pixels equipped with switching devices and a plurality of signal lines; a gray-scale voltage generation unit configured to generate a gray-scale reference voltage; and a data driving unit configured to generate a plurality of gray-scale voltages using the gray-scale reference voltage and apply the gray-scale voltages corresponding to an input image signal to data lines as data signals.

For example, an LCD includes two display substrates on which pixel electrodes and an opposite electrode are respectively formed, a liquid crystal layer disposed between the two display substrates and having dielectric anisotropy, and a backlight configured to emit light. The pixel electrodes are arranged in a matrix format and connected to respective switching devices such as thin film transistors (TFTs), and rows of the pixel electrodes sequentially receive data voltages one row at a time. The opposite electrode is formed on the whole surface of one of the display substrate and receives a common voltage Vcom. Desired images may be displayed by applying voltages to the pixel electrodes and the opposite electrode to generate electric fields across the liquid crystal layer, and adjusting the intensity of the electric fields to vary the transmittance of light passing through the liquid crystal layer.

In the case of displays including light emitting devices such as organic light emitting diode displays, transparent displays including open windows in some regions of display panels are under development for displaying texts or images while maintaining transparency.

### SUMMARY

One or more exemplary embodiments include a display apparatus and a method of driving the display apparatus.

One or more embodiments include a display apparatus and a method of driving the display apparatus that use a field sequential color (FSC) driving method in which timing for emitting color light is synchronized with timing for inputting pixel data to express colors.

Additional aspects will be set forth in part in the description which follows and, in part, will be apparent from the description, or may be learned by practice of the presented embodiments.

According to one or more exemplary embodiments, there is provided a method of driving a display apparatus, wherein the display apparatus includes a display panel having a plurality of pixels, a light source unit emitting light toward the display panel, and a control unit controlling the display panel and the light source unit. The method includes: displaying a light-emitting mode by operating the control unit to turn on a light source of the light source unit and transmit pixel data to the display panel; and displaying a non-light-emitting mode by operating the control unit to turn off the light source of the light source unit and turn on at least one pixel of the display panel.

According to one or more exemplary embodiments, a display apparatus includes: a display panel comprising a plurality of pixels; a light source unit emitting light toward the display panel; and a control unit controlling the display panel and the light source unit, wherein the control unit controls a light source of the light source unit to emit light and transmits pixel data to the display panel so as to display a light-emitting mode, and after the light-emitting mode, the control unit turns off the light source of the light source unit and turns on at least one pixel of the display panel so as to display a non-light-emitting mode.

These general and specific embodiments may be implemented by using a system, a method, a computer program, or a combination of the system, the method, and the computer program.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a view illustrating a display apparatus according to an exemplary embodiment;

FIG. 2 is a view illustrating a display apparatus according to another exemplary embodiment;

FIG. 3 is a block diagram illustrating an exemplary detailed structure of a display apparatus according to an exemplary embodiment;

FIG. 4 is a view illustrating a method of driving a display apparatus according to an exemplary embodiment; and

FIG. 5 is a flowchart illustrating a method of driving a display apparatus according to an exemplary embodiment.

### DETAILED DESCRIPTION

Reference will now be made in detail to exemplary embodiments, examples of which are illustrated in the accompanying drawings. Effects and features of the exemplary embodiments, and implementation methods thereof will be clarified through the following descriptions given with reference to the accompanying drawings. In this regard, the exemplary embodiments may have different forms and should not be construed as being limited to the descriptions set forth herein. As used herein, the term “and/or” includes any and all combinations of one or more of the associated listed items. Expressions such as “at least one of,” when preceding a list of elements, modify the entire list of elements and do not modify the individual elements of the list.

Hereinafter, the exemplary embodiments will be described in detail with reference to the accompanying drawings. In the drawings, like reference numerals denote like elements, and repetitive descriptions thereof will be omitted.

In the following descriptions of the exemplary embodiments, although the terms “first” and “second” are used to describe various elements, these elements should not be limited by these terms. These terms are only used to distinguish one element from another element. In the following descriptions of the exemplary embodiments, the terms of a singular form may include plural forms unless referred to the contrary. In the following descriptions of the exemplary embodiments, the meaning of “include,” “comprise,” “including,” or “comprising” specifies a property, a region, a fixed number, a step, a process, an element, a component, and a combination thereof but does not exclude other properties, regions, fixed numbers, steps, processes, elements, components, and combinations thereof. It will be understood that when a film, a region, or an element is referred to as being “above” or “on” another film, region, or element, it can be directly on the other film, region, or element, or intervening films, regions, or elements may also be present between the film, the region, or the element and the other film, region, or element.

In the drawings, the sizes of elements may be exaggerated for clarity. For example, in the drawings, the size or thickness of each element may be arbitrarily shown for illustrative purposes, and thus the inventive concept should not be construed as being limited thereto.

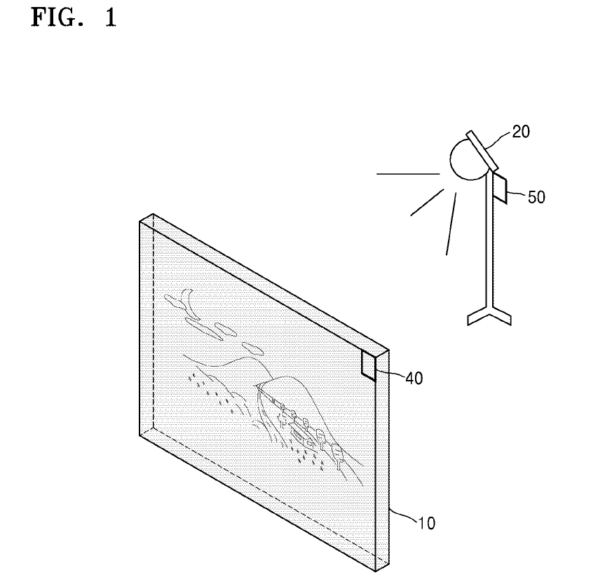

FIG. 1 is a view illustrating a display apparatus according to an exemplary embodiment. Referring to FIG. 1, the display apparatus of the exemplary embodiment includes a display unit 10 and a light source unit 20.

The display unit 10 displays images using pixels in the display unit 10. Light necessary for displaying images is supplied from the light source unit 20. The light source unit 20 includes a light source capable of emitting light toward the display unit 10. Pixel data to be input to the display unit 10 is synchronized with light-emitting timing of the light source unit 20.

The light source unit 20 may include a plurality of light sources capable of emitting light of different colors, and light having different colors may be sequentially emitted from the light source unit 20. For example, the light source unit 20 may include a first light source capable of emitting red light, a second light source capable of emitting green light, and a third light source capable of emitting blue light. However, the light colors of the light sources are not limited thereto.

The light source unit 20 may include light sources capable of proceeding substantially in a straight line, such as light emitting diodes (LEDs). However, the light source unit 20 is not limited thereto.

Pixel data is transmitted to the pixels of the display unit 10 in synchronization with light-emitting timing of the light source unit 20. The pixels are turned on or off according to the pixel data. If a pixel is turned on, the pixel transmits light emitted from the light source unit 20, and if a pixel is turned off, the pixel blocks light emitted from the light source unit 20. If a user sees the display unit 10 from the front side of FIG. 1, the user can see images displayed as shown in FIG. 1.

According to the exemplary embodiment, if a pixel is turned on when the light source unit 20 does not emit light, a user can see the rear side of the display unit 10 from the front side of the display unit 10. In this way, a transparent display may be realized.

As shown in FIG. 1, the display unit 10 and the light source unit 20 may be spatially separated and spaced apart from each other. The light source unit 20 may be freely installed at any location as long as the light source unit 20 does not cover a surface of the display unit 10, for example, as long as the light source unit 20 does not block ambient light from outside which is incident on the display unit 10. The light source unit 20 may communicate with the display unit 10 using wireless communication modules 50 and 40 disposed on the light source unit 20 and the display unit 10, respectively, or a cable connected between the light source unit 10 and the light source unit 20. The wireless communication module 40 and 50 may be a blue tooth communication module.

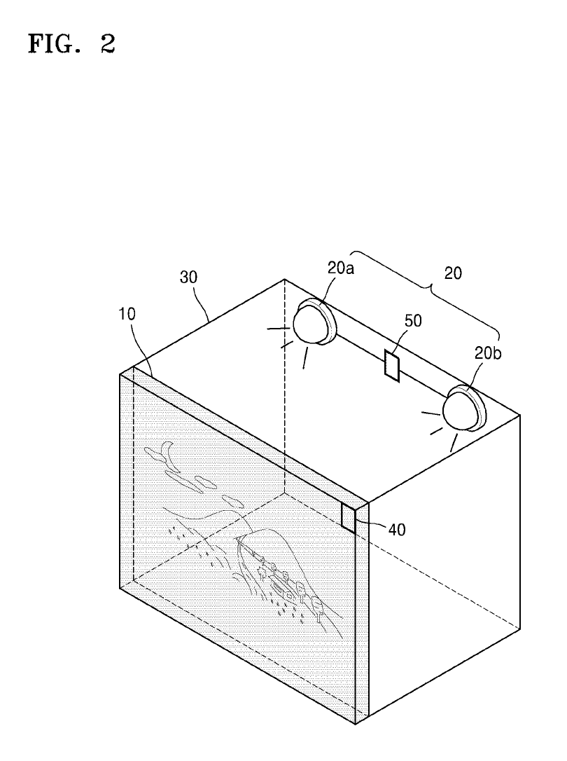

FIG. 2 is a view illustrating a display apparatus according to another exemplary embodiment. Referring to FIG. 2, the display apparatus of the other exemplary embodiment includes a display unit 10, a light source unit 20, and a frame 30. The display unit 10 and the light source unit 20 have the same functions as the functions of the display unit 10 and the light source unit 20 described with reference to FIG. 1, and thus descriptions thereof will not be repeated.

However, unlike in the exemplary embodiment described with reference to FIG. 1, the light source unit 20 of FIG. 2 includes a plurality of separate light source units 20a and 20b. Each of the light source units 20a and 20b may include light sources capable of emitting light of different colors. For example, each of the light source units 20a and 20b may include a first light source capable of emitting red light, a second light source capable of emitting green light, and a third light source capable of emitting blue light. Alternatively, the light source units 20a and 20b may include different kinds of light sources. The light source units 20a and 20b may be turned on in synchronization with the transmission timing of the pixel data.

Referring to FIG. 2, the display unit 10 and/or the light source unit 20 are fixed to the frame 30. The frame 30 may maintain a relative distance between the display unit 10 and the light source unit 20. The frame 30 may be formed of a particular resin. However, the frame 30 is not limited thereto. In addition, the frame 30 is not limited to the shape shown in FIG. 2. The display apparatus may be used as a showroom display apparatus. The light source unit 20 may communicate with the display unit 10 using wireless communication modules 50 and 40 disposed on the light source unit 20 and the display unit 10, respectively, or a cable connected between the light source unit 10 and the light source unit 20. The wireless communication module 40 and 50 may be a blue tooth communication module.

As illustrated in FIGS. 1 and 2, according to an exemplary embodiment, a display apparatus may include a light source unit 20 and a display unit 10 that are physically separable from each other. The light source unit 20 may communicate with the display unit 10 to synchronize the turn on time of a turn-on time of the light source and a transmission timing of the pixel data. The display apparatus may be a liquid crystal display apparatus. In this case, the display unit 10 may correspond to the liquid crystal display panel, and the light source unit 20 may correspond to a backlight of the liquid crystal display apparatus. However, the exemplary embodiments of the present disclosure are not limited thereto. For example, the inventive concept may be applied to various display apparatuses in which pixels transmit or block light emitted from a separate backlight to display images. Hereinafter, the exemplary embodiments of the present disclosure will be described based on liquid crystal display apparatuses. However, the exemplary embodiments of the present disclosure are not limited thereto.

In addition to the display device shown in FIGS. 1 and 2, a light source unit may be installed in various manners according to other exemplary embodiments. An exemplary embodiment provides a transparent display apparatus through which a user may see objects disposed at a rear side of the display apparatus. In this exemplary embodiment, a light source unit may be disposed at any position as long as an opaque material of the light source unit 20 does not block any surface of the display apparatus (For example, the light source unit 20 does not block the rear side of the display apparatus). For example, the light source unit may be disposed on a lateral side of a display panel of the display apparatus to emit light. The number and location of light source units may be variously determined. For example, if images are displayed on the front side of a display apparatus, light source units may be variously installed as long as the light source units do not block ambient light from outside which is incident on the display apparatus through the rear side of the display apparatus. The display unit 10 and the light source unit 20 in FIGS. 1 and 2 may have wireless communication modules 40 and 50, respectively. The wireless modules 40 and 50 may communicate each other for synchronization of the light source turned on timing of the light source unit 20 and the transmission timing of the pixel data. The light source units 20a and 20b in FIG. 2 may have a wireless communication module 50 commonly connected to the light source units 20a and 20b as shown in FIG. 2. However, the light source units 20a and 20b in FIG. 2 may have wireless communication module 50, respectively. The wireless communication module 40 and 50 may be a blue tooth communication module.

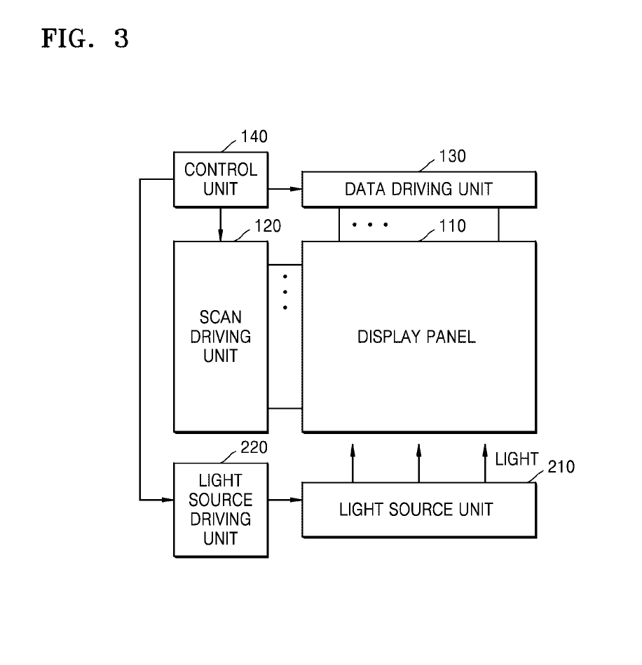

FIG. 3 is a block diagram illustrating an exemplary detailed structure of a display apparatus according to an exemplary embodiment.

Some elements of the display apparatus are omitted in FIG. 3 so as not to obscure the inventive concept of the exemplary embodiment. That is, those of ordinary skill in the art may easily understand that the display apparatus may further include other elements. Referring to FIG. 3, the display apparatus of the exemplary embodiment includes a display panel 110, a scan driving unit 120, a data driving unit 130, a control unit 140, a light source unit 210, and a light source driving unit 220.

The display panel 110 includes a plurality of pixels for displaying images. A plurality of scan lines and a plurality of data lines are arranged in the display panel 110. Each of the pixels may include a thin film transistor (TFT) as a switching device, a pixel electrode connected to the TFT, and an opposite electrode facing the pixel electrode with a liquid crystal layer being disposed therebetween. The alignment direction of the liquid crystal layer disposed between the pixel electrode and the opposite electrode is varied according to a voltage applied between the pixel electrode and the opposite electrode, and as a result, the pixel is turned on or off. The display panel 110 may include a diffusion layer so that light emitted from the light source unit 210 may uniformly propagate in the display panel 110.

The scan driving unit 120 transmits a scan signal sequentially to the scan lines of the display panel 110 according to a scan control signal received from the control unit 140. The data driving unit 130 transmits a data voltage to the data lines of the display panel 110 in synchronization with the scan signal according to a data control signal received from the control unit 140.

The control unit 140 may divide a frame into a light-emitting mode and a non-light-emitting mode, and may divide the light-emitting mode into a plurality of sub-frames. For example, the light-emitting mode may be divided into a first sub-frame emitting red light, a second sub-frame emitting green light, and a third sub-frame emitting blue light. The control unit 140 may receive a synchronization signal and a modulated clock signal according to each sub-frame from a system (not shown). The control unit 140 generates control signals for controlling the scan driving unit 120 and the data driving unit 130 based on the received signals. The control unit 140 receives pixel data from the system and aligns the pixel data according to a driving method for the display apparatus. Then, the control unit 140 transmits the aligned pixel data to the data driving unit 130, and the data driving unit 130 transmits the pixel data to the display panel 110.

The light source unit 210 includes a plurality of light sources emitting light of different colors toward the display panel 110. The light source driving unit 220 controls turn-on and turn-off operations of the light sources of the light source unit 210. The light source driving unit 220 may be controlled by the control unit 140. For example, the control unit 140 generates a control signal for controlling light-emitting timing of the light sources of the light source unit 210 such that the light sources may emit light according to the sub-frames.

In FIG. 3, the light source driving unit 220 receives a control signal from the control unit 140. However, the exemplary embodiments of the present disclosure are not limited thereto. For example, the exemplary embodiment illustrated in FIG. 3 may be variously modified as long as driving timing of the display panel 110 is synchronized with light-emitting timing of the light source unit 210. For example, a separate system control unit (not shown) may be used to control both the light source driving unit 220 and the control unit 140.

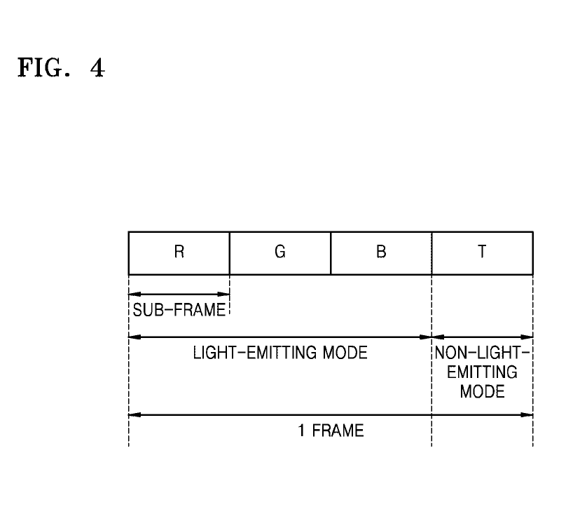

FIG. 4 is a view illustrating a method of driving a display apparatus according to an exemplary embodiment.

In the exemplary embodiment, driving timing for the display apparatus may include frames. FIG. 4 illustrates a single frame. Referring to FIG. 4, the frame may include a light-emitting mode and non-light-emitting mode. The light-emitting mode may include a plurality of sub-frames. As shown in FIG. 4, the light-emitting mode may include a sub-frame R for emitting red light, a sub-frame G for emitting green light, and a sub-frame B for emitting blue light.

During the sub-frame R, the control unit 140 outputs a control signal to the light source driving unit 220 so as to cause the light source unit 210 to emit red light, and controls the scan driving unit 120 and the data driving unit 130 so that the display panel 110 may receive data corresponding to red sub-frame. In the sub-frame G, the control unit 140 outputs a control signal to the light source driving unit 220 so as to cause the light source unit 210 to emit green light, and controls the scan driving unit 120 and the data driving unit 130 so that the display panel 110 may receive data corresponding to green sub-frame. In the sub-frame B, the control unit 140 outputs a control signal to the light source driving unit 220 so as to cause the light source unit 210 to emit blue light, and controls the scan driving unit 120 and the data driving unit 130 so that the display panel 110 may receive data corresponding to blue sub-frame. Colors mentioned in the description above are exemplary colors. That is, various colors may be applied to the exemplary embodiment according to a sub-frame configuration for the display apparatus.

If the display apparatus of the exemplary embodiment is driven at a frequency of 60 Hz, a single frame time may be about 16.7 ms. A light-emitting mode and a non-light-emitting mode may be a half of the single frame time, about 8.35 ms, respectively. In the exemplary embodiment shown in FIG. 4, each sub-frame may be one sixth of the single frame time, about 2.78 ms. Although not shown in FIG. 4, each sub-frame may include a data write time period for writing data on pixels, a liquid crystal response time period after the data writing, and a light source operation time period. The control unit 140 may transmit data to the display panel 110 and control the light source unit 210 according to the time periods of each sub-frame. For example, the control unit 140 may output control signals to the scan driving unit 120 and the data driving unit 130 so as to transmit data to the display panel 110 during the data write time period, and may output a control signal to the light source driving unit 220 such that the light source unit 210 may wait until liquid crystals are rearranged during the liquid crystal response time period and may control the light source driving unit 220 to emit light during the light source operation time period.

In the non-light-emitting mode, the control unit 140 may output a control signal to the light source driving unit 220 so as not to emit light, and may control the scan driving unit 120 and the data driving unit 130 such that the pixels may be turned on, that is, the pixels may receive maximum pixel data. Then, although the light source unit 210 is not turned on, ambient light may pass through from the display panel 110 from the rear side to the front side of the display panel 110. That is, a transparent display may be realized.

If light-emitting modes and non-light-emitting modes are alternately repeated, a user may see images displayed during the light-emitting modes and may see the rear side of the display panel 110 through the display panel 110 during the non-light-emitting modes, thereby realizing a transparent display.

The length of a non-light-emitting mode may be used as a variable for adjusting the transparency of the display apparatus. For example, the control unit 140 may adjust the length of a non-light-emitting mode according to a desired degree of transparency of the display apparatus. The desired degree of transparency may be determined according to a value input by a user or a preset value, or may be automatically determined according to various sensor observation values sensed by sensors. The control unit 140 may display light-emitting modes and non-light-emitting modes according to a length of the non-light-emitting mode. If the non-light-emitting mode length is increased, the transmittance and transparency of the display apparatus are increased.

Instead of the above-described method of obtaining a desired degree of transparency of the display apparatus by adjusting a non-light-emitting mode length, the number of turned-on pixels during a non-light-emitting mode may be adjusted to obtain a desired degree of transparency of the display apparatus. For example, the control unit 140 may set the number and positions of pixels to be turned on during a non-light-emitting mode according to a desired degree of transparency. In an exemplary embodiment, the control unit 140 may alternately turn on and off a plurality of pixels during a non-light-emitting mode. For example, during a non-light-emitting mode, odd-numbered pixels of a pixel line may be turned on, and even-numbered pixels of the pixel line may be turned off. In this manner, half of the pixels may be turned on during a non-light-emitting mode. If more pixels are turned on, the transmittance and transparency of the display apparatus are increased.

In addition, pixel data may be adjusted to control transparency of the display. For example, the control unit 140 may adjust gray-scale values of pixels during a non-light-emitting mode, so as to obtain a desired degree of transparency. If the gray-scaly values are increased, the transmittance and transparency of the display apparatus are increased.

A non-light-emitting mode may be included in all frames. The non-light-emitting mode may be included in predetermined frames only. As described above, a desired transparency may be obtained by adjusting numbers of frames including a non-light-emitting mode.

Referring to FIG. 4, the light-emitting mode and the non-light-emitting mode are separated. However, the light-emitting mode and the non-light-emitting mode may be partially overlapped with each other according to a driving method. Similarly, in FIG. 4, the sub-frames are separated. However, the sub-frames may be partially overlapped with each other according to a driving method.

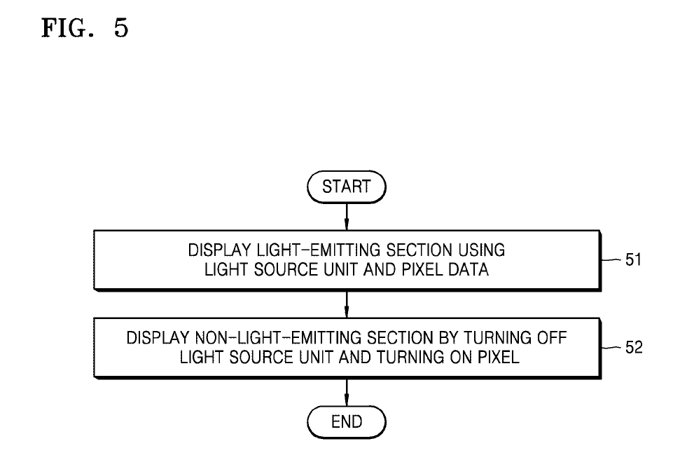

FIG. 5 is a flowchart illustrating a method of driving a display apparatus according to an exemplary embodiment.

The flowchart of FIG. 5 shows operations performed by the display apparatus shown in FIG. 3. Therefore, the above descriptions of the elements illustrated in FIG. 3 may be applied to the method explained below with reference to the flowchart of FIG. 5 although the descriptions are not repeated in the following description.

Referring to FIG. 5, in operation 51, the control unit 140 illustrated in FIG. 3 displays a light-emitting mode by using the light source unit 210 and pixel data. In detail, the control unit 140 of FIG. 3 displays the light-emitting mode by outputting a control signal to the light source driving unit 220 so as to control light emitting timing of the light source unit 210, and outputting control signals to the scan driving unit 120 and the data driving unit 130, which transmit a scan signal and a data signal to the display panel 110, so as to control pixel driving timing of the display panel 110.

In operation 52, the control unit 140 of FIG. 3 displays a non-light-emitting mode by turning off the light source unit 210 and maintaining pixel data in a turn-on state. In detail, the control unit 140 controls the scan driving unit 120 and the data driving unit 130 to transmit turn-on data to pixels and thus to allow ambient light to pass through the display panel 110 from the rear side to the front side of the display panel 110. At the same time, the control unit 140 turns off the light source unit 210. Then, instead of light emitted from the light source unit 210, ambient light passes through the display panel 110 from the rear side to the front side of the display panel 110, and thus a user may see a background through the display panel 110. That is, a transparent display may be realized.

In the above-described exemplary embodiments, a display region of the display panel 110 may be divided into a plurality of regions, and the plurality of regions may be driving in different modes. For example, the display region may be divided into a first region for displaying images and a second region that is transparent. The first region may driven as described above by using light-emitting modes and non-light-emitting modes or using only light-emitting modes, and the second region may be driven by using only non-light-emitting modes. In this case, a portion of the display panel 110 may be transparent, and the other portion of the display panel 110 may be used to display images. At this time, the light source unit 210 may emit light proceeding substantially in a straight line toward the first region but not toward the second region such that the second region may not transmit the light emitted from the light source unit 210 but may show the rear side of the display panel 110. In addition, various modifications may be made from the above-described exemplary embodiments.

As described above, one or more of the above exemplary embodiments provide a display apparatus and a method of driving the display apparatus for realizing a transparent display by a field sequential color (FSC) driving method.

According to the one or more of the above exemplary embodiments, the display apparatus includes a backlight, which is not blocking ambient light emitted to both surfaces of the display apparatus, and thus ambient light may pass through the display apparatus from one surface to another surface of the display apparatus, thereby realizing a transparent display apparatus. That is, one or more of the exemplary embodiments provide a transparent display apparatus and a method of driving the transparent display apparatus that are applicable to display apparatuses using backlights such as liquid crystal display apparatuses.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of driving a display apparatus, the display apparatus comprising a display panel having a plurality of pixels, a light source unit emitting light toward the display panel, and a control unit controlling the display panel and the light source unit, the method comprising:
displaying a light-emitting mode by operating the control unit to turn on a light source of the light source unit and transmit pixel data to the display panel; and
displaying a non-light-emitting mode by operating the control unit to turn off the light source of the light source unit and turn on at least one pixel of the display panel.

2. The method of claim 1, wherein the light source unit comprises a plurality of light sources emitting light of different colors,
the pixel data comprises a plurality of pieces of sub-pixel data, and
the light-emitting mode comprises a plurality of sub-frames,
wherein the displaying of the light-emitting mode is performed by turning on the plurality of light sources sequentially to generate light of different colors, and transmitting the plurality of pieces of sub-pixel data to the display panel to sequentially display the plurality of sub-frames.

3. The method of claim 1, wherein the non-light-emitting mode has a length according to a preset degree of transparency of the display panel.

4. The method of claim 1, wherein the displaying of the non-light-emitting mode is performed by turning on a certain number of pixels of the display panel according to a preset degree of transparency of the display panel.

5. The method of claim 1, wherein the pixels comprise pixel electrodes, an opposite electrode, and a liquid crystal layer disposed between the pixel electrodes and the opposite electrode,
wherein the displaying of the light-emitting mode and the non-light-emitting mode are performed by applying a turn-on voltage to the pixel electrodes to turn on the pixels and cause the liquid crystal layer to transmit light, and applying a turn-off voltage to the pixel electrodes to turn off the pixels and cause the liquid crystal layer to block light.

6. The method of claim of claim 1, wherein the display panel communicates with the light source unit using a wireless communication module disposed on the display panel and the light source unit, respectively.

7. The method of claim of claim 6, wherein the communication module on the display panel communicates with the communication module on the light source unit to synchronize a turn on time of the light source and a transmission timing of the pixel data.

8. The method of claim of claim 7, wherein the communication module is a blue tooth communication module.

9. The method of claim of claim 6, wherein the communication module is a blue tooth communication module.

10. A display apparatus comprising:
a display panel comprising a plurality of pixels;
a light source unit emitting light toward the display panel; and
a control unit controlling the display panel and the light source unit,
wherein the control unit controls a light source of the light source unit to emit light and transmits pixel data to the display panel so as to display a light-emitting mode, and after the light-emitting mode, the control unit turns off the light source of the light source unit and turns on at least one pixel of the display panel so as to display a non-light-emitting mode.

11. The display apparatus of claim 10, wherein the light source unit comprises a plurality of light sources emitting light of different colors,
the pixel data comprises a plurality of pieces of sub-pixel data, and
the light-emitting mode comprises a plurality of sub-frames,
wherein the control unit controls the light source unit to turn on the light sources of the light source sequentially to emit light of different colors, and controls a scan driving unit and a data driving unit of the display panel to transmit the plurality of pieces of sub-pixel data to the display panel so as to sequentially display the plurality of sub-frames.

12. The display apparatus of claim 10, wherein the non-light-emitting mode has a length according to a preset degree of transparency of the display panel.

13. The display apparatus of claim 10, wherein in the non-light-emitting mode, the control unit turns on a certain number of pixels of the display panel according to a preset degree of transparency of the display panel.

14. The display apparatus of claim 10, wherein the pixels comprise pixel electrodes, an opposite electrode, and a liquid crystal layer disposed between the pixel electrodes and the opposite electrode, and
wherein the control unit operate the pixels to be on or off, the control unit turns on the pixels by applying a turn-on voltage to the pixel electrodes so as to cause the liquid crystal layer to transmit light, and turns off the pixels by applying a turn-off voltage to the pixel electrodes to turn-off the pixels and cause the liquid crystal layer to block light.

15. The display apparatus of claim 10, further comprising a frame fixing a position of at least one selected from the display panel and the light source unit so as to fix the position of the light source unit relative to the display panel.

16. The display apparatus of claim 10, further comprising a wireless communication module on the display panel and the light source unit, respectively.

17. The display apparatus of claim 16, wherein the communication module on the display panel communicates with the communication module on the light source unit to synchronize a turn on time of the light source and a transmission timing of the pixel data.

18. The display apparatus of claim 17, wherein the wireless communication module is a blue tooth communication module.

19. The display apparatus of claim 16, wherein the wireless communication module is a blue tooth communication module.

20. A computer program stored on a medium for executing the method of claim 1.
